(19) United States
(12) Patent Application Publication
(10) Pub. No.: US 2026/0249200 A1
(43) Pub. Date: Aug. 27, 2026

(54) SYSTEM, METHOD, AND DEVICE FOR ANALYZING GAME PLAY VIDEO

(71) Applicant: WMC Analytics Inc., Toronto (CA)

(72) Inventors: Joshua Robinson, Toronto (CA); Mezbah Uddin, Toronto (CA)

(73) Assignee: WMC Analytics Inc., Toronto, ON (CA)

(21) Appl. No.: 18/863,017

(22) PCT Filed: Dec. 29, 2023
(86) PCT No.: PCT/CA2023/051775

§ 371 Date: Nov. 5, 2024

Related U.S. Application Data
(60) Provisional application No. 63/478,376, filed on Jan. 4, 2023.

(51) Int. Cl. A63F 13/798; A63F 13/497; G06V 10/764; G06V 20/40; G09B 19/22

(52) U.S. Cl. CPC A63F 13/798; A63F 13/497; G06V 10/764; G06V 20/44; G09B 19/22

(57) ABSTRACT

A computer implemented system and method for analyzing gameplay files to provide a training assessment. The system includes an input module to receive a raw replay file from a game, game platform, or user and provide the raw replay file to a parsing module. The parsing module is configured to parse each raw replay file and classify the parsed replay file as any event type indicated by feature data of the parsed replay file. Where the parsed replay file is classified as at least one event type, the parsing module saves the parsed replay file in an event dataset. The parsing module extracts game events from the parsed replay file and saves the game events in an event table schema. The input module may be integrated into a backend of a game or a game platform. The system may include a training assessment module configured to generate the training assessment.

### TECHNICAL FIELD

The following relates generally to methods for analyzing video files, and more particularly to systems, methods, and devices for analyzing video capture files of a game play to provide an assessment.

### INTRODUCTION

Video game play has gotten increasingly competitive. International leagues associations and tournaments have brought electronic sports (E-sports) from solely a casual leisure activity to a level of competition often on par with traditional sports. This legitimization has brought with it the promise of endorsements, winnings and gainful employment.

For love of the games and to secure these incentives there is also increasing pressure for players to improve their skills and perform at/achieve higher levels. While training can often mimic that of traditional sports, differences arise due to the unique goals of players of video games compared to traditional sports. For example, advancement such as rank advancement, in an E-sport may be awarded based on an assessed in-game performance rather than solely wins or losses. Furthermore, the more controlled environment of programed video games increases the likelihood that events will substantially repeat themselves in the digital space over traditional sports. Additionally, methods of data collection such as video capture of game play (or replays) are far more readily available in E-sports over traditional sports.

Training programs based on video capture have previously been limited to manual review such as described in US 2021/0170230 A1 to Tormasov et al. published Jun. 10, 2021. Furthermore, these systems are directed towards video analysis of players' physical actions and generating training recommendations based on these physical actions rather than analyzing video game play event which may or may not be the result in a video game context of player actions outside of the video game. Furthermore, these systems can be slow and cumbersome due to the large amounts of video which does not indicate a player's performance.

Additionally, predictive artificially intelligence in the context of video game play has been employed to predict odds of occurrences such as winning or placement often in the context of betting odds. However, these systems and methods are directed towards predicting outcomes rather than influencing them.

Furthermore, as they do not benefit the players directly, the predictive models are less likely to be responsive to gameplay as they do not inherently incentivize players to contribute video captures for updating the training of the model.

Accordingly, there is a need for an improved system, method, and device for generating and delivering video game training.

### SUMMARY

Provided herein is a computer implemented system for analyzing video capture files of a game play to provide a training assessment. The system includes an input module configured to receive at least one raw replay file from one or more of a game, a game platform, and a user and provide the raw replay file to a parsing module. The system further includes the parsing module. The parsing module is configured to parse each raw replay file to obtain a corresponding parsed replay file and classify the parsed replay file wherein the parsed replay file is classified as any event type indicated by feature data of the parsed replay file. Where the parsed replay file is classified as at least one event type, the parsing module is configured to save the parsed replay file in an event dataset. The parsing module is further configured to extract game event data from the saved parsed replay file and save the game event data in an event table schema.

The input module may be integrated into a backend of a game or a game platform.

The input module may provide an interface for one or more of a game, a game platform, and a user to upload the raw replay file.

The system may further include a training assessment module. The training assessment module may be configured to generate the training assessment based on the event dataset data, the event table schema data, and a trained model.

The trained model may compare the event dataset data to a benchmark. The benchmark may be determined based on one more of a path of least resistance calculation and a question and answer calculation.

The trained model may be a machine learning model.

The training assessment may include at least one suggested skill focus for a player.

The suggested skill focus may be based on a goal and the skill of a set of potential skills that is determined based on the event data set to be the least lacking skill to reach the goal.

The input module may be further configured to receive a batch comprising a plurality of raw replay files. Duplicate raw replay files may be filtered out by the input module.

According to another aspect provided herein is a computer implemented system for analyzing video capture files of a game play to provide a training assessment including a parsing module configured to format at least one video file into a model class object, extract feature data from the model class object, identify at least one event instance based on the feature data and an event mapping, extract the event instance and at least one corresponding data point from the model class object, and save the extracted event instance and corresponding data point in an event data set; and a training assessment module configured to generate the training assessment based on the event data set and a training.

The training assessment may include at least one suggested skill focus for a player.

The suggested skill focus may be based on goal and the skill of a set of potential skills that is determined based on the event data set to be the least lacking skill to reach the goal.

Formatting the video file may further include serializing a binary stream of the video file into one or more of a string and text file and deserializing the one or more string and text file into the root model class object.

The binary stream may include one or more of metadata, network stream data, frame data, and keyframe data.

The system may further include a video capture upload module configured to upload the video file by a user wherein the uploading comprises a plurality of video files in a batch and wherein duplicate video files are filtered out.

The training may be based on a training data and wherein the training data includes a plurality of input training assessments wherein the input training assessments include at least one first training assessment wherein the first training assessment is a training assessment of the training assessment generator.

The text file may be of a JavaScript Object Notation (JSON) format.

The event data set may be one or more of a parquet format, tabular format and a comma separated value format.

The training may be based on a training data and wherein the training data is training data corresponding to one or more of a game line and a game type.

The system may further include a video capture upload module configured to upload a video file wherein the video file is provided by one or more of a user, a video game, and a video game platform.

The feature data may include one or more of features relating to game mechanics, feature relating to reaction times, metadata, in-game actions, player basic information, team selection information, play selection, player car position information, ball position information, player car demolish information, player car jump information, dodge information, double jump information, weapon choice information, team shooting information, individual map positioning/distance information, team map positioning/distance information, drop site information, map rotation information, character selection information, decision tree when ranking up information, team character makeup information, map positioning information, and team fighting information.

The event dataset may be a subset of the data of the model class object. The event dataset may correspond to one or more of a player and a team.

The training assessment module may be a machine learning model.

According to another aspect provided herein is a computer implemented method for analyzing video capture files of a game play to provide a training assessment including formatting at least one video file into a model class object, extracting feature data from the model class object, identifying at least one event instance based on the feature data and an event mapping, extracting the event instance and at least one corresponding data point from the model class object, saving the extracted event instance and corresponding data point in an event data set, and generating the training assessment by a training assessment generator based on the event data set and a training.

The training assessment may include at least one suggested skill focus for a player.

The suggested skill focus may be based on goal and the skill of a set of potential skills that is determined based on the event data set to be the least lacking skill to reach the goal.

Formatting the video file may further include serializing a binary stream of the video file into one or more of a string and text file and deserializing the one or more string and text file into the root model class object.

The binary stream may include one or more of metadata, network stream data, frame data, and keyframe data.

The method may further include uploading the video file by a user wherein the uploading comprises a plurality of video files in a batch and wherein duplicate video files are filtered out.

The training may be based on a training data and wherein the training data includes a plurality of input training assessments wherein the input training assessments include at least one first training assessment wherein the first training assessment is a training assessment of the training assessment generator.

The text file may be of a JavaScript Object Notation (JSON) format.

The event data set may be one or more of a parquet format, a tabular format, and a comma separated value format.

The training may be based on a training data and wherein the training data is training data corresponding to one or more of a game line and a game type.

The method may further include uploading a video file wherein the video file is provided by one or more of a user, a video game, and a video game platform.

The feature data may include one or more of features relating to game mechanics, feature relating to reaction times, metadata, in-game actions, player basic information, team selection information, play selection, player car position information, ball position information, player car demolish information, player car jump information, dodge information, double jump information, weapon choice information, team shooting information, individual positioning/distance map information, team positioning/distance information, drop site information, map rotation information, character selection information, decision tree when ranking up information, team character makeup information, map positioning information, and team fighting information.

The event dataset may be a subset of the data of the model class object. The event dataset may correspond to one or more of a player and a team.

The training assessment generator may be a machine learning model.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a computer network configured to analyze a video capture file for generating a training assessment, according to an embodiment;

FIG. 2 is a block diagram of a device of FIG. 1, according to an embodiment;

FIG. 3A is a block diagram of a computer system of FIG. 1 configured to analyze an event dataset for generating a training assessment, according to an embodiment;

FIG. 3B is a block diagram of a computer system of FIG. 3A configured to analyze a video capture file for generating an event dataset, according to an embodiment;

FIG. 4 is a block diagram of a background job handler of FIG. 3B, according to an embodiment;

FIG. 5 is a representation of an event mapping of FIG. 3B, according to an embodiment;

FIG. 6 is a block diagram of an event dataset and event table schema obtaining portion of the system of FIG. 3B, according to an embodiment;

FIGS. 7A through 7C are a flow diagrams of a method to analyze a video file into an event dataset of FIG. 3B, according to an embodiment;

FIG. 8 is a flow diagram of a method of analyzing a video capture file for generating a training assessment, according to an embodiment;

FIG. 9 is a flow diagram for recursively training a training assessment machine learning model, according to an embodiment;

FIG. 10 is a flow diagram of a path of least resistance calculation method of generating and suggest the training assessment of FIG. 8, according to an embodiment; and

FIG. 11 is a flow diagram of a question and answer benchmark calculation method of generating and suggesting the training assessment of FIG. 8, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

The systems, methods, and devices of the present disclosure relate generally to a method for generating and providing assessment to players of video games. The assessments are generated by parsing game events and relevant gameplay data out of obtained gameplay data such video capture. The game events and gameplay data are evaluated against benchmarks for assessing the players gameplay and providing personalized coaching.

The game play data may be obtained (i.e. uploaded to the system) directly from the game or game platform or from a user such as a player or concerned party like a coach. Regardless of the source, the system may be integrated into the game or platform, interface with the game or platform, or be a stand alone system. While specific games may be discussed herein, it is expressly contemplated that system may accommodate various game play and gaming platforms.

The collective file size of the parsed out game events and relevant gameplay data is generally significantly smaller than the obtained gameplay data. Therefore, the parsing beneficially reduces the data amount that is analyzed by the training assessment module, described below, to generate the training assessment. Furthermore, the reduction in file size is beneficial for data storage purposes. The reduction reduces the file size while the event data set is in the que to be processed by the training for processing que purposes as well as storage for additional analysis such as by second training assessment generator which may have been trained with a different training data set. The event dataset is input into a machine learning artificial intelligence model, referred to herein as the training assessment module. The training assessment module is commonly referred to as a training assessment generator. The training assessment module generates and provides an assessment of the player based on the event dataset. The assessment may include a suggestion of where the player should focus on improving to achieve a goal such as leveling up (i.e. a path of least resistance).

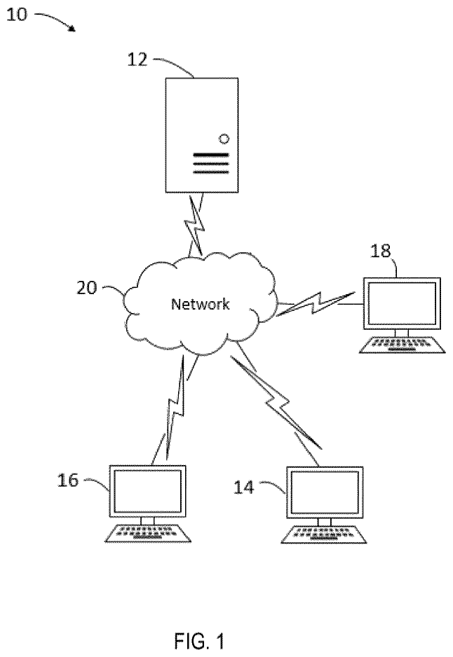

Referring now to FIG. 1, shown therein is a block diagram illustrating a system 10, in accordance with an embodiment. The system 10 includes a server platform 12 which communicates with at least one cloud service device 14, a plurality of player devices 16, and at least one administrator device 18 via a network 20. The server platform 12 also communicates with a plurality of user devices 22. The server platform 12 may be a purpose built machine designed specifically for analyzing video capture files of a game play to provide an assessment based on a machine learning model.

The server platform 12, cloud service devices 14, player devices 16, administrator devices 18 and user devices 22 may be a server computer, desktop computer, notebook computer, tablet, PDA, smartphone, or another computing device. The devices 12, 14, 16, 18, 22 may include a connection with the network 20 such as a wired or wireless connection to the Internet. In some cases, the network 20 may include other types of computer or telecommunication networks. The devices 12, 14, 16, 18, 22 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage devices may include a hard disk drive, floppy disk drive, CD drive, DVD drive, Blu-ray drive, or other types of non-volatile data storage. Processors may execute applications, computer readable instructions or programs. The applications, computer readable instructions or programs may be stored in memory or in secondary storage, or may be received from the Internet or other network 20. Input device may include any device for entering information into device 12, 14, 16, 18, 22. For example, input device may be a keyboard, key pad, cursor-control device, touch-screen, camera, microphone, mouse, controller, or switch/console controller. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 12, 14, 16, 18, 22 may include multiple of any one or more of processors, applications, software modules, second storage devices, network connections, input devices, output devices, and display devices.

Although devices 12, 14, 16, 18, 22 are described with various components, one skilled in the art will appreciate that the devices 12, 14, 16, 18, 22 may in some cases contain fewer, additional or different components. In addition, although aspects of an implementation of the devices 12, 14, 16, 18, 22 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the devices 12, 14, 16, 18, 22 and/or processor to perform a particular method.

In the description that follows, devices such as server platform 12, cloud service devices 14, player devices 16, administrator devices 18, and user devices 22 are described performing certain acts. It will be appreciated that any one or more of these devices may perform an act automatically or in response to an interaction by a user of that device. That is, the user of the device may manipulate one or more input devices (e.g. touchscreen, mouse, button, keyboard, controller, switch/console controller) causing the device to perform the described act. In many cases, this aspect may not be described below, but it will be understood.

As an example, it is described below that the devices 12, 14, 16, 18, 22 may send information to the server platform 12. For example, a user using the player device 16 may manipulate one or more input devices (e.g. a mouse, keyboard, controller, switch, and console controller) to interact with a user interface displayed on a display of the player device 16. Generally, the device may receive a user interface from the network 20 (e.g. in the form of a webpage). Alternatively, or in addition, a user interface may be stored locally at a device (e.g. a cache of a webpage or a mobile application).

Server platform 12 may be configured to receive a plurality of information, from each of the plurality of cloud service devices 14, player devices 16, administrator devices 18, and user devices 22. Generally, the information may comprise at least an identifier identifying the cloud service, player, administrator, and/or user. For example, the information may comprise one or more of a username, e-mail address, password, or social media handle.

In response to receiving information, the server platform 12 may store the information in storage database. The storage database may be one or more of relational service, PostGreSQL, Microsoft® Sequel® (MS SQL) Server or a timescale database. The storage may correspond with secondary storage of the device 12, 14, 16, 18, 22. Generally, the storage database may be any suitable storage device such as a hard disk drive, a solid state drive, a memory card, or a disk (e.g. CD, DVD, or Blu-ray etc.). Also, the storage database may be locally connected with server platform 12. In some cases, storage database may be located remotely from server platform 12 and accessible to server platform 12 across a network for example. In some cases, storage database may comprise one or more storage devices located at a networked cloud storage provider.

The cloud service device 14 may be associated with a cloud account. Similarly, the player device 16 may be associated with a player account, the administrator device 18 may be associated with an administrator account, and the user device 22 may be associated with a user account. Any suitable mechanism for associating a device with an account is expressly contemplated. In some cases, a device may be associated with an account by sending credentials (e.g. a cookie, login, or password etc.) to the server platform 12. The server platform 12 may verify the credentials (e.g. determine that the received password matches a password associated with the account). If a device is associated with an account, the server platform 12 may consider further acts by that device to be associated with that account.

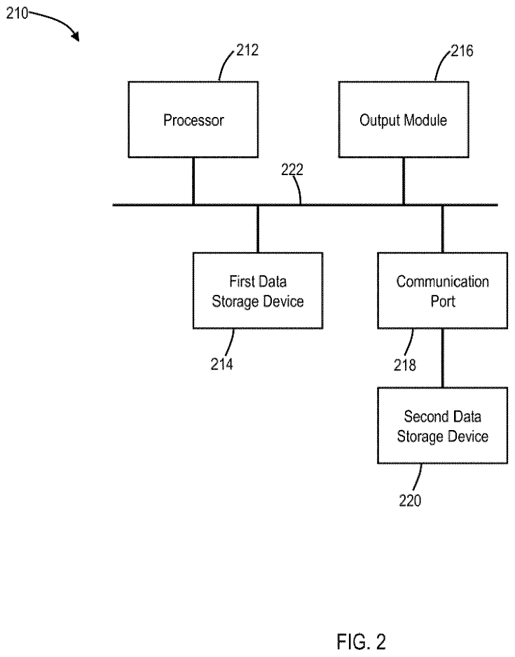

Referring now to FIG. 2, shown therein is a block diagram of a device 210 of a system such as the system 10 of FIG. 1, according to an embodiment. The device 210 may be one or more of the devices 12, 14, 16, 18, and 22 of FIG. 1.

The device 210 includes a processor 212, a first data storage device 214, an output module 216, a communication port 218 and a second data storage device 220 coupled to the communication port 20. In this embodiment, the various components 212, 214, 216, 218 of the device 210 are operatively coupled using a system bus 222.

The device 210 may be various electronic devices such as personal computers, networked computers, portable computers, portable electronic devices, personal digital assistants, laptops, desktops, mobile phones, smart phones, tablets, and so on.

In some examples, the first data storage device 214 may be a hard disk drive, a solid-state drive, or any other form of suitable data storage device and/or memory that may be used in various electronic devices. The data storage device 214 may have various data stored thereon. Generally, the data stored on the data storage device 214 includes video game capture data, event data including training data, and assessment data.

In the embodiment as shown, another data storage device in addition to the first data storage device 214, namely the second data storage device 220, is provided. The second data storage device 220 may be used to store computer-executable instructions that can be executed by the processor 212 to configure the processor 212 to analyze video capture data stored in the first data storage device 214 or of a video capture file acquired from the first data storage device 214 and stored in the second data storage device 220.

It should be noted that it is not necessary to provide a second data storage device 220, and in other embodiments, the instructions may be stored in the first data storage device 214 or any other data storage device.

In some cases, the first data storage device 214 may be a data storage device external to the device 210 or processor 212. For example, the first data storage device 214 may be a data storage component of an external computing device (e.g. a mobile phone, a laptop computer, or cloud service device). In such cases, the processor 212 may be configured to execute computer-executable instructions (stored in second data storage device 220) to acquire a video capture file of the first data storage device 214 and store the video capture file in the second data storage device 220.

The processor 212 may be configured to provide a user interface to the output module 216. The output module 216, for example, may be a suitable display device (e.g. a monitor) coupled to the processor 212. The user interface allows the processor 212 to solicit input from a user regarding various types of operations to be performed by the processor 212. The user interface also allows for the display of various output data and determinations, such as a training assessment, generated by the processor 212.

The device 210 may be a server computer, desktop computer, notebook computer, tablet, PDA, smartphone, or another computing device. The device 10 may include a connection with a network such the network 20 of FIG. 1. In some cases, the network may be wired or wireless connection to the Internet. In some cases, the network may include other types of computer or telecommunication networks. The device 210 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor 212 may execute applications, computer readable instructions or programs. The applications, computer readable instructions or programs may be stored in memory or in secondary storage or may be received from the Internet or other network. Input device may include any device for entering information into device 210. For example, input device may be a keyboard, keypad, cursor-control device, touchscreen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 210 may include multiple of any one or more of processors, applications, software modules, second storage devices, network connections, input devices, output devices, and display devices.

Although device 210 is described with various components, one skilled in the art will appreciate that the device 210 may in some cases contain fewer, additional or different components. In addition, although aspects of an implementation of the device 210 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the device 210 and/or processor 212 to perform a particular method.

In the description that follows, devices such as device 210 are described performing certain acts. It will be appreciated that any one or more of these devices may perform an act automatically or in response to an interaction by a user of that device. That is, the user of the device may manipulate one or more input devices (e.g. a touchscreen, a mouse, a button, a keyboard, controller, switch/console controller) causing the device to perform the described act. In many cases, this aspect may not be described below, but it will be understood.

As an example, a user using the device 210 may manipulate one or more input devices (not shown; e.g. a mouse, a keyboard, controller, switch/console controller) to interact with a user interface displayed on a display of the device 210. In some cases, the device 210 may generate and/or receive a user interface from the network (e.g. in the form of a webpage). Alternatively, or in addition, a user interface may be stored locally at a device (e.g. a cache of a webpage or a mobile application).

In response to receiving information, the device 210 may store the information in storage database. The storage may correspond with secondary storage of the device 210. Generally, the storage database may be any suitable storage device such as a hard disk drive, a solid state drive, a memory card, or a disk (e.g. CD, DVD, or Blu-ray etc.). Also, the storage database may be locally connected with the device 210. In some cases, storage database may be located remotely from device 210 and accessible to device 210 across a network for example. In some cases, storage database may comprise one or more storage devices located at a networked cloud storage provider.

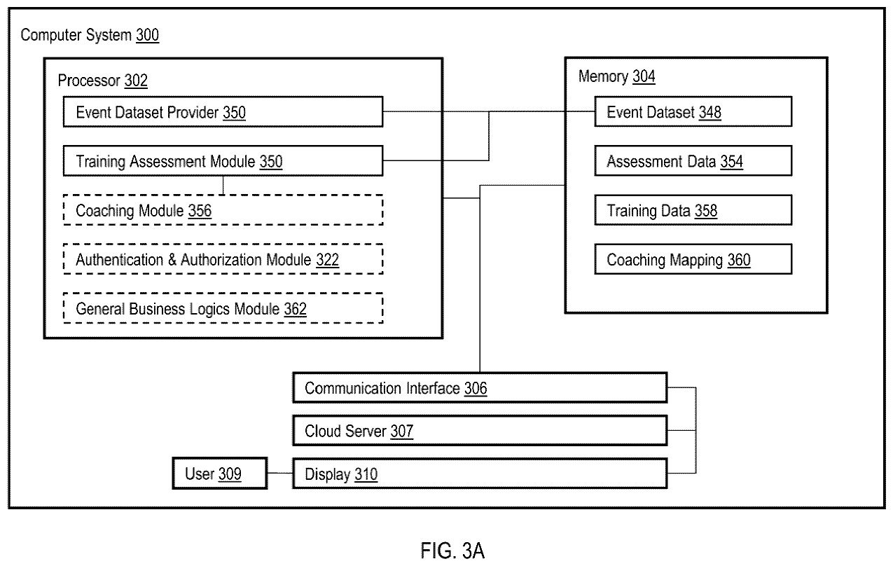

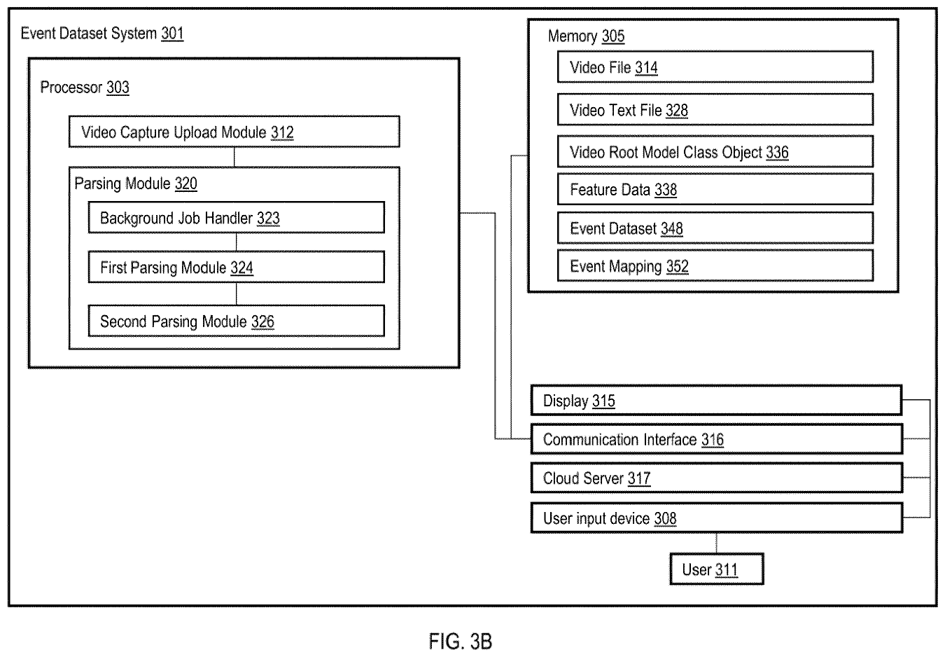

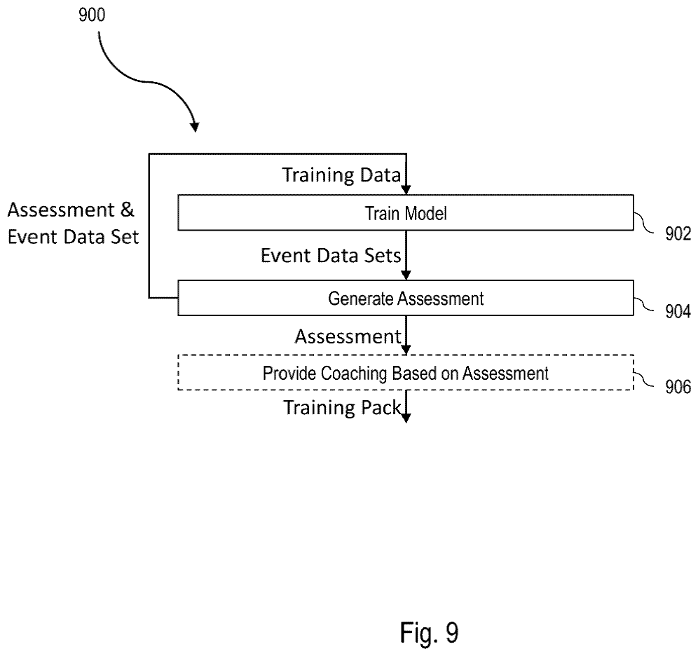

Referring now to FIG. 3A, shown therein is a block diagram of a computer system 300 configured to analyze an event dataset 348, according to an embodiment. The computer system 300 may be the system 10 of FIG. 1. The computer system 300 may be configured to implement the method 900 of FIG. 9. Aspects of the computer system 900 (e.g. memory, processor, modules/engines, stored data, etc.) may be implemented at a single computing device or across a plurality of computing devices. The system 900 may be web based.

The system 300 includes a processor 302. The processor 302 is configured to analyze an event dataset 348 to generate a training assessment data 354.

The system 300 further includes a memory 304. The memory 304 is communicatively connected to the processor 302. The memory 304 stores computer-executable instructions which, when executed by the processor 302, cause the computer system 300 to perform the functions and provide the functionalities described herein, such as performing video file parsing. The memory 304 also stores data such as the event dataset 348 used by the processor 302 to perform the functions and provide the functionalities described herein. The memory 304 may also store data which is output when the executable instructions are executed by the processor 302. The memory 304 may include one or more memory devices or data storage devices. For example, the memory 304 may include one or more of storage device 214 and storage device 220 of FIG. 2. In embodiments where the memory 304 includes multiple memory or data storage devices, the multiple memory or data storage devices may be implemented at a single computing device or across multiple computing devices. In an example, the memory 304 includes a timescaled database or webhosted database.

The system 300 further includes a communication interface 306. The communication interface 306 is configured to transmit and receive data to and from the computer system 300. In an embodiment, the communication interface 306 may include a network interface for communicating with one or more networked computing devices such as the cloud server 307 and display 310.

The system 300 further includes a cloud server 307. The cloud server is configured to host a backend of the system 300. The backend may include the processor 302 and/or the memory 304. The cloud server 307 may host data of the system 300, such as application code, video files, video text files, event datasets, and training assessments, all further described below. The cloud server 307 may further host applications of the system 300, such as a parsing module 320 (or its various components) of FIG. 3B, a job scheduler 323 of FIG. 3B, a training assessment module 350, and a coaching module 356, all further described below. In an embodiment, the cloud server 307 hosts the data on a repository such as Github®. In a further embodiment the cloud server 307 hosts the applications on a cloud service such as Amazon Web Services® (AWS). The repository and the cloud service are communicatively connected. The cloud service pulls the code from the repository and runs it using a processing service of the cloud service.

The system 300 further includes a display 310. The display 310 is configured to display an output generated by the processor 302 such as a training assessment. In an embodiment, the display 310 may display a graphical user interface configured to receive user input such that a user 309 can interact with the system 300 and view outputs generated thereby.

The system 300 further includes an event dataset provider 349. In an embodiment, the event dataset 348 may be the event dataset system 301 of FIG. 3B. In a further embodiment, the event dataset provider 349 is a game such as Rocket League® and/or a hosting platform such as Steam®. In this embodiment the event dataset 348 may be generated from sources other than video files such as backend data of the video game. This data may be restricted or only available to the game or hosting platform. Therefore, the hosting platform or game may have access to the data used to generate the event dataset 348 without needing to analyze a video file. As such, the hosting platform or game may generate the event dataset 348 from sources other than video files.

The processor further includes a training assessment module 350. The training assessment module 350 is configured to generate an assessment data 354. The training assessment module 350 is configured to analyze at least one event dataset 348 to generate the assessment data 354.

The training assessment module 350 is a machine learning model. The training assessment module 350 generates training assessments 354 based on training data 358. The training data for a training assessment generator may be stored in a single training data file. The training data file may be .csv, and/or a parquet file.

The machine learning model may be a classification model. The classification model may be one or more of rule based and mapping based. For example, the classification model may base what results in a ceiling shot based on a velocity, car rotation, ball position, and shot dynamics.

The machine learning model may further be a recommender model. The recommender model may recommend a path of least resistance and/or corresponding training pack based on all in game events performance of a player of a certain rank to move to the next level. The rank and/or recommendation may be based on a match making rank (MMR). The MMR is a numerical representation of a rank of a player. The rank, and therefore the MMR increases as the player wins and decreases as the player loses. The machine learning model may ping an application program interface (API) to retrieve the MMR. The machine learning model may ingest data linked to the MMR and use it to create a rank based benchmark.

The assessment data 354 includes suggested focuses for player training practice. The assessment data 354 may further include suggested actions for the player to take. These suggested actions may act as coaching. The suggested focus may be directed to a performance of a specific skill. The skill is identified by the training assessment module 350 as a skill of the player that is lacking or has gaps in performance. The lacking and/or gaps may be relative to benchmark such as an average ranking for peer players and/or relative to an in game goal. The suggested focuses may be based on multiple skills identified and a degree to which each skill is lacking and/or has gaps. In an example, the training assessment may suggest focusing on skill that are the least lacking and/or gapped skill relative to a potential benchmark such as a level up. In this example, the training assessment generator will suggest the player focus on the skills that will achieve their goal with the least amount of effort. In this way, the player is provided with a path of least resistance to achieve their goal such as a skill rating goal.

The assessment data 354 may be one or more of saved in the memory 304 and provide to the display 310 for review by a user 309. The assessment data 354 may be saved in a timescale database or webhosted. At least one saved assessment of the assessment data 354 may be reviewed along with at least one current assessment of the assessment data 354 to track performance over time and/or to monitor progress against specific skills and overall raking in game.

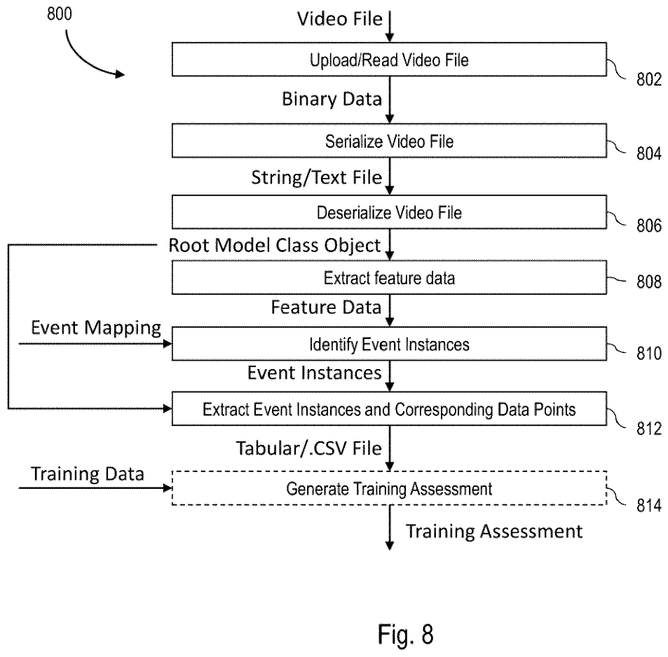

Referring now to FIG. 3B, shown therein is a block diagram of an event dataset system 301 configured for analyzing a video capture file, according to an embodiment. The event dataset system 301 may be the event dataset provider 349 of FIG. 3A. The event dataset system 301 may be configured to implement the method 800 of FIG. 8. Aspects of the event dataset system 301 (e.g. memory, processor, modules/engines, stored data, etc.) may be implemented at a single computing device or across a plurality of computing devices. The event dataset system 301 may be web based. It will be appreciated that where the event dataset system 301 is hosted by a game or gamming platform, the event dataset system 301 may serve as an interface between the analysis system of FIG. 3A and the game or gamming platform.

The event dataset system 301 includes a processor 303. The processor 303 is configured to analyze a video capture file to generate an event dataset 348. The processor 303 may be the processor 302 of FIG. 3A. The event data system 301 further includes a memory 305. The memory 305 may be the memory 304 of FIG. 3A.

The event dataset system 301 further includes a user input device 308. The user input device 308 is configured to receive a user input from a user 311 interacting with the event dataset system 301. The user 311 may be the user 309 of FIG. 3A. The processor 303 may generate user input data in response to the user input received via the user input device 308 and store the user input data in memory 305. The user input data may then be used by the processor 303 to control operation of the event dataset system 301. The user input device 308 may be a website, a gaming platform such as Steam® or Epic®, and/or a gaming console such as a PlayStation®. The user input device 308 may have users to login to provide an input. The login may be login specific to the user input device 308 such as with an email/password combination or may be a platform login that identifies the player based on a gaming platform ID.

In an embodiment, the user 311 is a player such that the user is the person who the video file 314 further described below corresponds to. In a further embodiment, the user 311 is an interested party such as a coach or trainer of the player. In this example, the user 311 may have provided the interested party with the video files 314 or access to them. In a further embodiment, the user 311 is a platform, such as the Steam®, on which the video game is hosted. In this example, the hosting platform has access to the video files based on the hosting platform hosting of the video game. In a further embodiment, the user 311 is the video game. In this example the video game has access to the video files 314 as they are generated by the video game. These embodiments are not mutually exclusive in that a user may be one or more of a player, an interested party, a hosting platform, and the video game.

The event dataset system 301 may further include a display 315. The display 315 may be the display 310 of FIG. 3A. The display 315 may be configured to display a list of recordings for the games where the user 3011 has been tagged a part of as indicated by at least one upload by the user 311 and/or uploaded by teammates who the user 311 played with.

The event dataset system 301 includes a cloud server 317. The cloud server 317 may be the cloud server 307 of FIG. 3B. The cloud server 306 is configured to host the backend of the event dataset system 301.

The event dataset system 301 further includes a communication interface 316. The communication interface 316 may be the communication interface 306 of FIG. 3A. The communication interface is configured to transmit and receive data to and from the event dataset system 301. In an embodiment, the communication interface 316 may include a network interface for communicating with one or more networked computing devices such as the cloud server 317, user input device 308, and display 315.

The processor 303 includes a video capture upload module 312. The video capture upload module 312 is configured to receive a video file 314, further described below. The video capture upload module 314 may receive the video file 314 when a user uploads the video file 314.

The upload may be automatic in that after a plugin is opted in by a user, video files 314 are seamlessly uploaded upon plugin detecting a video file 314 was created. The video capture upload module may include a BakkesMod® Auto Uploader. In embodiments where the user 311 is a hosting platform and/or a video game, the video file 314 may be uploaded via the communication interface 306 directly to the video capture upload module 312. In embodiments where the user 311 is a player or interested party, the video file 314 may be uploaded via the user input device 308.

The video file 314 may also be referred to as a replay or video capture file. The video file may be a .replay file. The video file 314 includes game data of the of a game play. The game data may be timestamped. The game data may indicate inputs of a player during the game play directed to producing an in game event and/or action. The inputs may include timestamped logged keystrokes and clicking a trigger of a game controller. The inputs may be made on an input device such as a keyboard, mouse, controller, switch/console controller. The in game events and/or actions may include the in game event such as an acceleration, shooting of a gun. The video file may be a raw binary file. The video file 314 may include metadata, network stream data, frame data (i.e. timestamped image), and/or keyframe data.

The video capture upload module 312 is further configured to read the video file 314. Reading the video file 314 configures the video file 314 into a parsable format.

The processor 303 further includes a parsing module 320. The parsing module is configured to receive the video file 314 from the video capture upload module 312. The parsing module configured to parse the video file 314 into an event dataset 348 further described below.

The parsing module 320 includes a background job handler 323. Typically, a plurality of video files 314 are received by the parsing module 320. The parsing module 320 may not be able to parse a first video file before receiving a second video file. The background job handler 323 manages a queue of the received video files 314 for parsing.

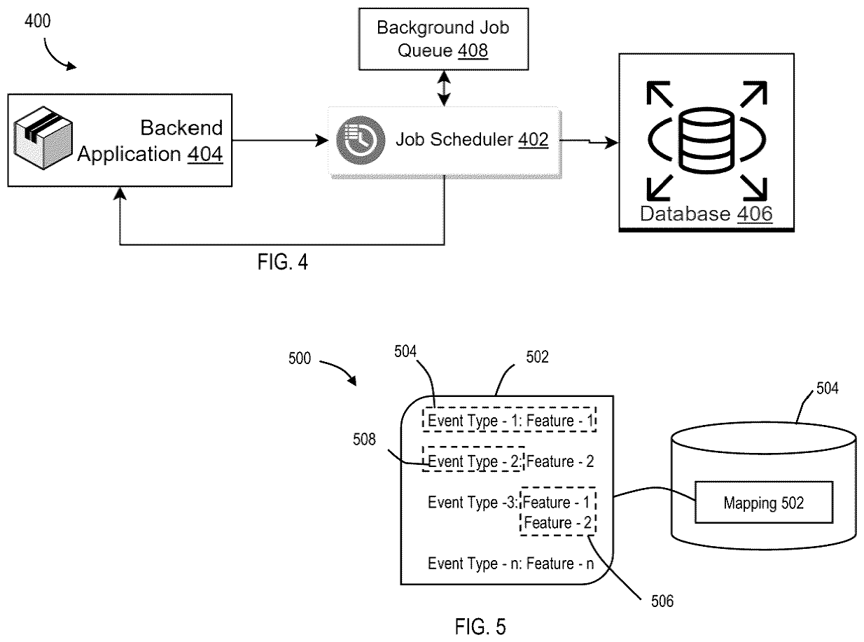

Referring now to FIG. 4, shown therein is a block diagram of a background job handler 400, according to an embodiment. The background job handler 400 may be the background job handler 323 of FIG. 3B.

The background job handler 400 includes a job scheduler 402. The job scheduler 402 is configured to receive each video file and adds it to a background job queue 408. As the backend service 404 parses video files the job scheduler 402 is configured to add the resultant event dataset to a database 406. The database 406 may be a timescaled database or relational database service (RDS) database. The job scheduler 402 is configured to request the backend service 404 to execute another job, namely parse another video file. The job scheduler 402 and background job queue may be a Hangfire® job scheduler.

Referring back to FIG. 3B, the parsing module 320 further includes a first parsing module 324. The first parsing module 324 is configured to receive the read video file 314 from the video capture upload module. The first parsing module is configured to parse the video file into a video text file 328. The first parsing module 324 may be an open source parsing module. The first parsing module 324 may be written in the C-sharp (C#) or ASP.NET language.

Parsing the video file into a video text file 328 may include converting the video file into a binary stream. The first parsing module 324 further reads the binary stream step by step and serializes the binary stream into a string. Serialization is the process of converting the state of an object, that is, the values of its properties, into a form that can be stored or transmitted. The serialized form doesn't include any information about an object's associated methods. The serialization of the binary stream may also format the string. The formatting of the string may be based on a data input configuration of the second parsing module 326, further described below. The video text file 328 may be human readable. The video text file 328 may be of a JavaScript Object Notation (JSON) format.

The parsing module 320 further includes a second parsing module 326. The second parsing module 326 is configured to receive the video text file 328 from the first parsing module 324 and parses it into an event dataset 348.

As a preliminary step, the second parsing module 326 is further configured to deserialize the video text file 328 into a video root model class object 336. The video root model class object 336 may be saved a raw parquet. In an example, the raw parquet is a .parquet file. Deserialization reconstructs an object from the serialized form. The second parsing module 326 may include a NewtonSoft package to deserialize the video text file 328. In an example, the video root model class object 336 is saved in an s3 bucket of the memory 305.

In an example, goals is the root object. The root object is necessary to identify what the game data represents. Defining a root class enables writing the root object into a csv which wherein the information may be converted into multiple columns, for different information such as time of goal, player name, and player team.

In an example the root class is goals:

```
“Root object” :: ″Goals″: [
  { ″Time″: 61.29993, ″PlayerName″: ″Player_1″, ″PlayerTeam″: 1 },
  { ″Time″: 101.597786, ″PlayerName″: ″Player_1″, ″PlayerTeam″: 1 },
  { ″Time″: 142.169479, ″PlayerName″: ″Player_1″, ″PlayerTeam″: 1 },
  { ″Time″: 173.786758, ″PlayerName″: ″Player_2″, ″PlayerTeam″: 0 },
  { ″Time″: 189.496246, ″PlayerName″: ″Player_2″, ″PlayerTeam″: 0 },
  { ″Time″: 253.880692, ″PlayerName″: ″Player_3″, ″PlayerTeam″: 1 },
  { ″Time″: 368.054138, ″PlayerName″: ″Player_1″, ″PlayerTeam″: 1 }
```

The second parsing module 326 may further parse the video root model class object based on a trigger. The trigger may indicate that video root model class object is waiting to be processed. In an example, the trigger is an AWS® Lambda® trigger. The trigger may launch a script, such as a Python™ script. The python script may parse the video root model class object for all in game event generation tasks and output a parquet file which includes aggregated time stamp based data for all featured in game events identified by player. The further parsed video root model class object may be output as an analytical parquet. The output of an analytical parquet may trigger and second trigger. The second trigger may select and aggregate relevant data from the analytical parquet and write it to the timescale database or webhosted database. The second trigger may be processed using C# programming language.

The second parsing module 326 is further configured to extract feature data 338 of the video root model class object 336. The feature data 338 includes features relating to game mechanics and reaction times. For example, if a player takes more shots which leads to more goals and more wins, that would be identified as important. Features are determined to be important (featured) based on a contribution to player wins and/or losses. The features that are featured may vary particularly across different levels of gameplay. If a type of shot is identified frequently at a rank that has a higher probability of being scored, it is identified as being an important shot type. The features may be of game metadata and/or in-game actions.

The features may include player basic information, team selection information, play selection such as from a play book, player car position information, ball position information, player car demolish information, player car jump information, dodge information and double jump information. These features may correspond to a sport type video game such as Rocket League®. These features may further include weapon choice information, team shooting, individual map positioning/distance information, team map positioning/distance information, drop site information, map rotation information. These features may correspond to first person shooter (FPS) or third person type video games. These features may further include character selection information, decision tree when ranking up information, team character makeup information, map positioning information, and team fighting information. These features may correspond to multiplayer online battle arena (MOBA) type games.

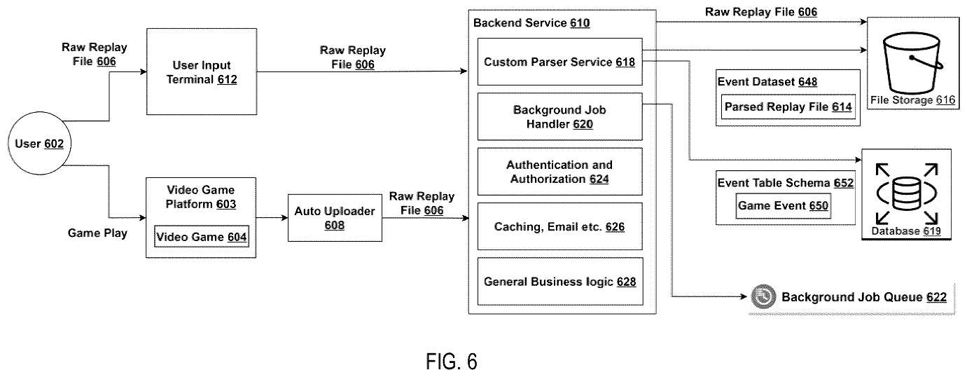

Referring now to FIG. 5, shown therein is a representation 500 of an event mapping 502, according to an embodiment. The event mapping 502 may be the event mapping 353 of FIG. 3B.

The event mapping includes a plurality of mappings 504. Each mapping 504 includes a feature 506 and a corresponding event type 508. The mappings 504 may act as key: value pairs in which the feature 506 is the key and the event type 508 is the value. In an example, the event mapping 502 may act as a lookup data structure where the key 506 can be used (by the second parsing module 326 of FIG. 3B) to look up whether there is a corresponding mapped value 508. The feature 506 may be limited by a range such that the object of the feature 508 occurs with one or more parameters of the range to be a feature 508. The feature 506 may be a feature set including a plurality of features and ranges.

In an example, the feature of a shot with the player positioned at a z distance (feature 506) is mapped to a ceiling shot (event type 508)

“ceiling shot”: {
“player's_Z_position” : 2028 <= maxInThePastThreeSeconds(z) < 2040 ,
“Ball_Z_postion” : average(z) > 215,
“player_match_shot” : True
}

Referring back to FIG. 3B, the second parsing module 326 is further configured to identify event instances corresponding to each event type. Event instances may be characterized by the completion of an in game task (i.e. jump through the red hoop), performing a task in a certain manner (i.e. get to the checkpoint without hitting any civilians), and/or achieving a certain benchmark such (i.e. score a certain amount of goals). Event instances may include actions taken by the player, occurrences scripted into the game such as the appearance of an object or a combination of both.

Event instances are identified by the second parsing module by looking up a feature or feature set of each event instance in an event mapping 352 and retrieving the corresponding event type value. The event mapping 352 is stored in the memory 305.

The second parsing module 326 is further configured to extract event instances identified of each event type and corresponding data points. The extracted event instances and corresponding data points are saved in an event dataset 348. The event dataset 348 may be the event dataset 348 of FIG. 3A. The event dataset 348 may further include an event table schema which records event type for each event instance. The event table schema may include identifying data for each event instance such as player ID, Event ID, time ID, and Game ID (i.e. Rocket League®).

The event dataset 348 is a parsed dataset (classified and trimmed). By extracting identified event instances, the event dataset 348 includes only event data that corresponds to predetermined event types. As the event data set is a subset of the event instances received by the event dataset system 301, the event dataset 348 is smaller in size than a full event dataset including all the event instances. Even though the event dataset 348 is a subset, by mapping the event instances the event instances relevant to determining the assessment are saved. The subset nature of the event dataset 348 maintains the quality of the assessment while beneficially reducing the processing necessary and increasing the speed of determining the assessment. For example, the subset removes the need for the training assessment module 350 of FIG. 3A to analyze the video root model class object or any file it is generated from. Furthermore, the event dataset is much smaller for storage purposes. This is beneficial both for processing queue purposes as well as storage for additional analysis such as by second training assessment generator which may have been trained with a different training data set.

The event dataset 348 includes multiple data entries. Each data entry corresponds to an identified event instance. Each data entry includes information that identifies the event instance to which it corresponds. Each data entry may further include a time stamp for the event instance. The time stamp may indicate a time in the video capture that the event instance occurred and/or was completed.

Each data entry includes at least one data point. Each data point includes data pertaining to the corresponding event instance such as a reaction to the event instance or the time it took to complete a task. The data point may indicate a player's performance in relation to the corresponding event instance.

Each event dataset 348 may be a player event dataset. A player event dataset includes event data derived from video files 314 corresponding to a specific player's game play. Therefore, the player event dataset indicates the specific player's performance in the video game based on the specific player's performance in relation to the identified event instances. The player event dataset may include player identification (ID) information. The player ID information may include one or more of a username and a user ID number.

Alternatively, the event dataset 348 may be a team event dataset. A team event dataset includes event data derived from video files 314 corresponding to a group of player's game play. Typically, the group of players are linked as a team by some form of collaborative play. Therefore, the team event dataset indicates the specific team's performance in the video game based on the team's performance in relation to the identified event instances. This performance may indicate individual team member performance and/or the collaborative performance of the team. The team event dataset may include team identification (ID) information. The team ID information may include one or more of a team name and a team ID number.

A format of the event dataset 348 may be of one or more of tabular, comma separated value format, and parquet. The comma separated value format may be referred to as a .csv format. The parquet format may be an Apache® parquet. An Apache® parquet is an open source, column-oriented data file format designed for efficient data storage and retrieval. It provides efficient data compression and encoding schemes with enhanced performance to handle complex data in bulk. Parquet is available in multiple languages including Java, C++, Python. A parquet may be beneficial due to the high compression rate and fast return of data for large query runs. The event dataset 348 may be timescaled.

Referring back to FIG. 3A the processor 302 may further include a coaching module 356. The coaching module 356 is configured to suggest actions for a player based on the assessment data 354. The suggested actions may be referred to as a training pack. The suggested actions may be the determined by a coaching machine learning model of the coaching module 356. The suggested actions may further be determined by looking up the assessment data 354 in a coaching mapping 360 or based on a rule set. The coaching mapping 360 may be a mapping data structure including mappings of event types or other key data of the event dataset to suggested actions (i.e. coaching).

The coaching module 356 may further be configured to produce advanced analytics, interactive visualizations such as heatmaps and charts, and training-pack solutions. The coaching module may produce these via Spark® integration. This integration may be through Sagemaker® and/or Amazon Web Services® glue or container based.

The processor may further include an authentication & authorization module 322. The authentication & authorization module 322 is configured to receive a login to the system 300. The login may be login specific to a user input device such as the user input device 308 of FIG. 3B or may be a platform login that identifies the player based on a gaming platform ID. The login may be received via such a user input device. Alternatively, the login may be credentials that were verified prior to a user 309 interfacing with the system such as a certificate of a host platform.

The processor may further include a general business logics module 362. The business logistics module is configured to process payments by a user 309 such as for training packs. The payment processing may be via an online payment service such as Stripe®. The general business logics module 362 may be further configured to support auto-renewal of a user's payment.

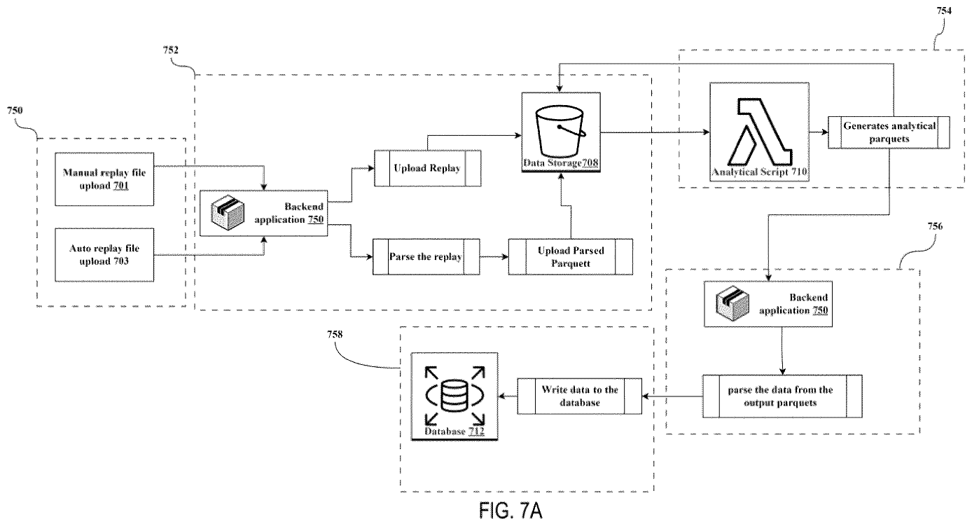

Referring now to FIG. 6, shown therein is a block diagram a system 600 for analyzing a video file 606 into an event dataset 614 and event table schema 652, according to an embodiment. The system 600 may be the system 300 of FIG. 3B.

The system 600 includes a user 602. The user 602 is a player who plays a video game 604. The video game 604 is a game where the play is substantially occurs on a computer based on an input from the user 602.

The system 600 further includes a video game platform 603. The video game platform 603 hosts a video game 604. Hosting may include providing one or more of the sever(s) on which the video game 604 is played, login support, and data storage for video game data such as a video file 606.

The system 600 further includes the video game 604 may be a sports game such as Rocket League®.

The video game 604 and/or the video game platform 603 is configured to capture a video file 606. A video file 606 is captured of the game play of the video game 604 by the user 602. The video file may be the video file 314 of FIG. 3B.

The system 600 further includes an auto-uploader 608. The auto-uploader 608 may be the user input device 308 of FIG. 3B. The auto uploader 608 is configured to automatically upload video files 606 that are captured, to a backend 610 of the system 600, further described below. The upload may occur without the need for user 602 input following the capture of the video file 606. The auto-uploader 608 may include permissions that restrict which video files 606 are uploaded. The permissions may include a user opt-in such that only video files corresponding to a user 602 who has opted-in are uploaded. Opting-in may include one or more of installing and/or accepting the terms of a plug-in and fulfilling a user obligation such as paying a subscription fee or providing a volume of replays. The auto-uploader 608 may be a BakkesMod® auto uploader.

The system 600 further includes a user input terminal 612. The input terminal 612 may be the user input device 308 of FIG. 3B. The user input terminal 612 provides an interface for the user 602 to upload video files 606 to the backend 610. The input terminal 612 is configured to receive video files 602 either individually or as a batch. The user input terminal 612 may be a browser.

The system 600 further includes the backend service 610. The backend service 610 may be referred to as a backend application 610 or backend 610. The backend service processes the video file 606 into a parsed replay file 614.

The system 600 further includes a file storage 616. Backend service 610 is communicatively connected to the file storage 616. The file storage 616 may be the memory 305 of FIG. 3B.

The backend service 610 includes a custom parse engine 618. The custom parse engine 618 may be the second parsing module 326 of FIG. 3B. The custom parse engine 618 parses the video file 606 or a derivative thereof to obtain a parsed replay file 614.

The custom parse engine 618 further analyzes the parsed replay file 614 to categorize the parsed video file 614 based on event type. It is expressly contemplated that a video file 606 may be of multiple event types or no event types. Each video file 606 that is categorized into at least one event type is saved in the file storage 616 in an event dataset 648. The event dataset 648 may be an embodiment of the event dataset 348 of FIG. 3B. By providing only categorized video files 606 the event dataset is a trimmed subset of a data set including the all of the raw replay files 606. Categorizing and trimming the full set of raw replay files 606 into an event dataset 648 minimizes the parsed replay files 614 the modules such as the training assessment module 350 of FIG. 3A processes by maintaining and identifying relevant raw replay files 606.

The custom parse engine 618 may further obtain game events 650 for each parsed replay file 614. In an embodiment, each game event 650 may be obtained by running a script of the custom parse engine. The script may be a script such as a Java® script hosted on a web hosted service such as AWS® Lambda®. The game events 650 includes an event type field with at least one value indicating the event type or types of the corresponding parsed replay file 614. The game events 650 also include identification data such as player ID, Event ID, time ID, and Game ID (i.e. Rocket League®) for identifying the corresponding parsed replay file 614. The game events 650 may be saved in an event table schema 652. The custom parse engine 618 may provide the event table schema 652 to a time database 619, such as a timescale database or webhosted database.

A timescale database is a database that is specially designed to store and retrieve information that has timestamps. Compared to traditional databases (Microsoft® Sequel® (Sql®) server, Oracle®, etc.), timescale databases have better compression rates and return results faster (1000×) on average.

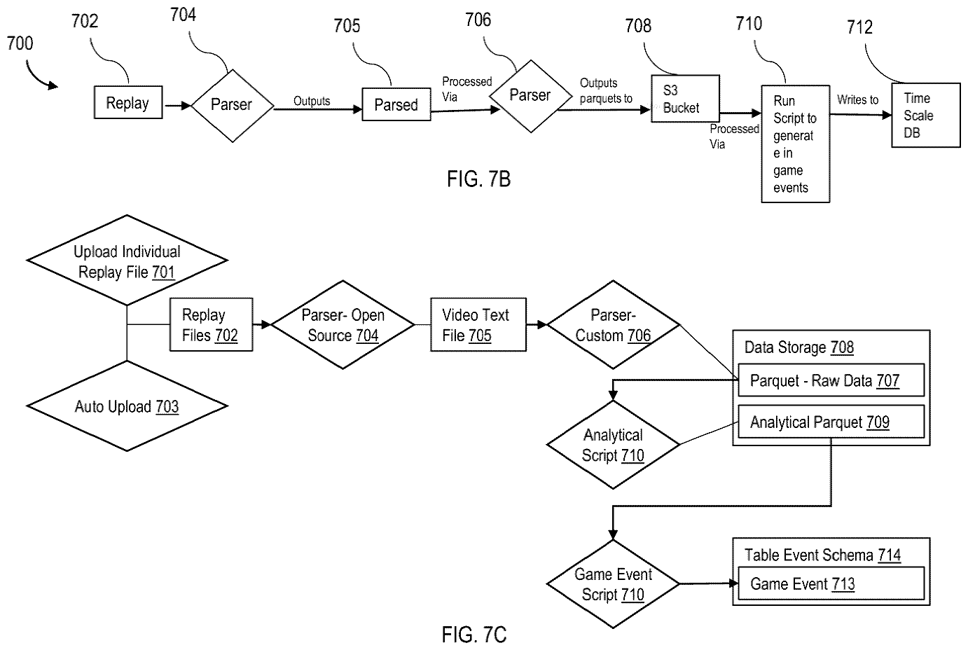

The backend service 610 further includes a background job handler 620. The background job handler manages a background job queue 622 of the system. By managing the background job queue 622 the background job handler 620 is configured to manage an order in which video files 606 are processed. The background job queue 622 includes an ordered list of video files 606. The background job queue 622 may be the background job handler 323 of FIG. 3B and/or 700 of FIG. 7.

The backend service 610 further includes an authentication & authorization module 624. The authentication & authorization module 624 is configured to authenticate credentials of the user 602 such as an email/password combination and/or a platform credential of the video game platform 603. The authentication & authorization module 604 is further configured to authorize a user 602 to upload video files 606 upon authentication. The authentication & authorization module 624 may be the authentication & authorization module 322 of FIG. 3A.

The backend service 610 further includes a caching and email module 626. The caching and email module 626 is configured to cache video files 606 prior to parsing.

The backend service 610 further includes a general business logics module 628. The business logics module 628 is configured to receive and manage payments. The business logics module 628 may be the business logics module 362 of FIG. 3A.

Referring now to FIG. 7A through 7C, shown therein are flow diagrams of a method 700, to analyze a video file into an event dataset, according to various embodiments.

At 750, a replay 702 is obtained in raw binary stream format. The replay file 702 may be obtained via individual or manual upload 701 such as by a player or a concerned party such as a coach. The replay file 702 may be obtained via an auto uploader, such as a Bakkesmod® uploader. It will be appreciated that the replay files may be obtained directly from a game, a platform hosting the game or from a player or concerned party who has previously obtained the replay from the game 702.

At 752, the replay 702 is provided to an open source replay parser 704 on a backend application 750. The open source replay parser 704 may be the first parsing module 324 of FIG. 3B. The open source replay parser 704 outputs a video text file 705 in a JSON format to a custom parser 706. The custom parser 706 may be the second parsing module 326 of FIG. 3B. The custom parser 706 parses the replays 702 into raw parquets 707, also referred to as raw data parquets 707. The raw data parquets 707 and the replays 702 are output or upload, to a data storage 708, also referred to as a S3 Bucket 708. The data storage 708 may be the memory 305 of FIG. 3B.

At 754, the raw parquet 707 being received by the data storage 708 triggers an analytical script 710. Each raw parquet 707 is further processed by the analytical script 710 into an analytical parquet 709. Processing the raw parquet 707 into the analytical parquet 709 includes classifying the analyzed parquet 709 by event type. The analytical script 710 saves or uploads analytical parquets 709 corresponding to at least one event type to the data storage 708. The save analytical parquets 707 to form an event dataset such as the event dataset 348 of FIG. 3B. The analytical parquets 707 may be use an in house built and trained AI model to classify game events in the game as further described at 900 of FIG. 9.

At 756, the analytical parquet 707 being received by the data storage 708 triggers a game event script 711. The game event script 711 parses game events 713 from the analytical parquet 709. The trigger may be a simple queue service (SQS) message.

At 758, the script writes the game events 713 to a table event schema 714, also known as aggregated events 714 on a database 712.

Referring now to FIG. 8, shown therein is a flow diagram 800 of a method of analyzing a video file to generate a training assessment, according to an embodiment.

At 802, at least one video file is uploaded to a video capture upload module. Video files may be uploaded individually or as a batch of multiple video captures. The video capture upload module may filter out duplicate video captures. Processing duplicate video files may bias the training data of the training assessment module further described below. By filtering duplicate video files, this bias is beneficially reduced. Furthermore, rather than duplicating the generation of a training assessment for duplicate video captures, the duplicate video is filtered out and the previous training assessment of the corresponding video capture is provided to the player.

Duplicate video captures may be identified by a parsing the video file initially with a lightweight parser. The lightweight parser parses video file identifying information for identifying the video file such as a video file Id and/or player identifying information. A video table (in an example ReplayFileInfo) that stores video file information (with replay id) and a player table (in an example PlayersReplayInfo) that stores player information such as player Id is checked for the video file identifying information. If the check indicates a duplicate file, the video capture upload module may return a message to the front end indicating the result. In an example, the message is “This replay file is already uploaded.”

At 804, the video file is parsed by a first parser of the parsing module into a video text file. The video text file may be human readable. The text file may be of a JavaScript Object Notation (JSON) format. The first parser may be open source. The first parser may be written in the C-sharp (C#) or ASP.NET language. The parsing of the first parser converts the video file into a binary stream. The binary stream includes one or more of metadata, network stream data, frame data, and keyframe data. The first parser further reads the binary stream step by step. The first parser further serializes the binary stream into a string. The serialization of the binary stream may also format the string. The formatting of the string may be based on a data input configuration of the second parser, further described below.

At 806, data of the text video file is deserialized into a video root model class object. The deserialization may be accomplished by a second parser. The second parser may include a NewtonSoft package.

At 808, feature data of the video root model class object is extracted. The feature data may be the feature data 338 of FIG. 3B.

At 810, event instances are identified. The extracted features are analyzed and mapped to known event types of an event mapping. Event instances may be characterized by the completion of an in game task (i.e. jump through the red hoop), performing a task in a certain manner (i.e. get to the checkpoint without hitting any civilians), and/or achieving a certain benchmark such (i.e. score a certain amount of goals). Event instances may include actions taken by the player, occurrences scripted into the game such as the appearance of an object or a combination of both. Event instances significant to an assessment may be identified by a set of features as indicated in the event mapping.

At 812, identified event instances and corresponding data points are extracted from the video root model class object to an event dataset. By extracting identified event instances, the event dataset includes only event data that is relevant to determining the assessment. This removes the need for the training assessment generator, described below to analyze the video root model class object or any file it is generated from which are likely far greater in size. Furthermore, event dataset is much smaller for storage purposes. This is beneficial both for processing queue purposes as well as storage for additional analysis such as by second training assessment generator which may have been trained with a different training data set.

At 814, a training assessment is generated. The training assessment is generated by a training assessment generator. The training assessment generator is a machine learning model. The training assessment generator analyzes at least one event dataset to generate training assessments based on the event dataset input. The training assessments generator generates training assessments further based on a training, further described below.

The training assessment generator generates a training assessment corresponding to a current event dataset. The training assessment includes suggested focuses for player training practice. The training assessment may further include suggested actions for the player to take. The training assessment may be directed to a specific skill. The skill is identified by the training assessment generator as a skill of the player that is lacking. The lacking may be relative to benchmark such as an average ranking for peer players and/or relative to an in game goal and/or rank. The suggested focuses may be based on multiple skills identified and a degree to which each skill is lacking. In an example, the training assessment may suggest focusing on skill that are the least lacking skill relative to a potential benchmark such as a level up. In this example, the training assessment generator will suggest the player focus on the skills that will achieve their goal with the least amount of effort. In this way, the player is provided with a path of least resistance to achieve their goal.

The training assessment generator generates training assessments based on a training. The training assessment generator compares the current event dataset to event datasets input during the training. Based on similarities between the current event data set and the training event datasets and a correspondence between each training event dataset and the corresponding training assessment, the training assessment generator generates a training assessment corresponding to the current event dataset. The similarities may be multidimensional in that multiple data points across multiple event instances may be compared.

Referring now to FIG. 9, shown there is a flow diagram of a method 900 for training a training assessment module and generating a training assessment, according to an embodiment. The training assessment generator generates training assessments based on a training.

At 902, the training assessment generator is initially trained with initial training data. The initial training data includes multiple event datasets and corresponding assessments. The event data sets are analyzed by the training assessment generator and a model is generated based on the analysis and corresponding assessments. The training assessment corresponding to each event dataset of the initial training data is determined by a person such as an expert for a plurality of training event datasets.

At 904, an assessment is generated based on a provided event data set and the trained model of the training assessment generator. The assessment pair with the corresponding event dataset may be used to update the training data and retrain the model. In this way each time the training assessment generator generates a training assessment it may be further training itself. This method of continuous training updates the training assessment generator and adapts it to changes in game play.

The training assessment generator may be trained for a specific game or part thereof. The training assessment generator may also be trained for a video game line wherein the context and game play are similar. The training assessment generator may also be trained for a type of video game such as one of sports games, role playing games (RPGs), and first person shooters. Across video game lines and video game types features of events, performance measures, and the resultant training assessments may share commonalities. As such it may be beneficial to have a common training assessment generator across games in these categories.

At 906, suggestions and information are provided for a player based on the assessment. The suggested actions may be referred to as a training pack. The information may include analytics and interactive visualizations such as heatmaps and charts. The suggested actions and information may be the determined by a coaching machine learning model. The suggested actions may further be determined by looking up the assessment data in a coaching mapping or based on a rule set. The coaching mapping may be a mapping data structure including mappings of event types or other key data of the event dataset to suggested actions (i.e. coaching).

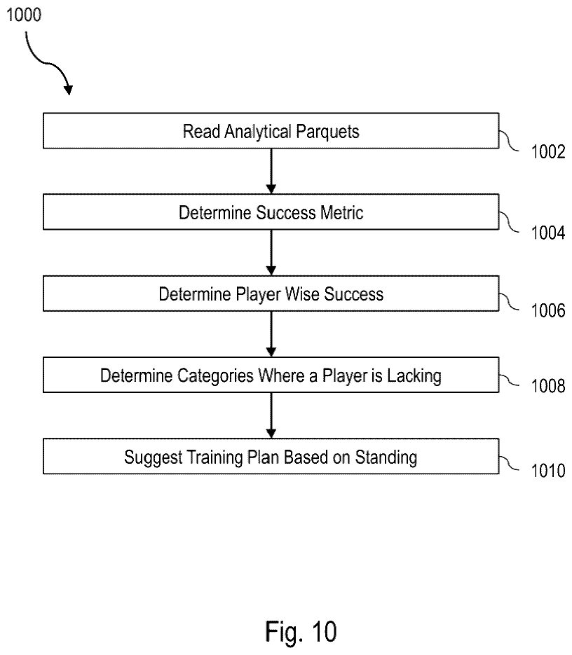

Referring to FIG. 10, show therein is a flow diagram a method 1000 of determining and suggesting a training plan, according to and embodiment. The method 1000 may be a path of least resistance (POLR) benchmark calculation.

At 1002, the method 1000 includes reading analytical parquets of an event dataset such as the analytical parquets 709 of FIG. 7C. Reading the analytical parquets may be via a computation resources and configuration, such as a Databricks® cluster.

At 1004, the method 1000 includes determining success metric for a group of players in at least one category. Example categories include offensive or defensive. Each category is defined by one or more event types. A player who has a low value in the success metric indicates that the player is lacking in the category. Determining the success metrics is based off the data read at 1002 or in conjunction with determining the player wise success, at 1006, further described below. The group of players may be all players of the system corresponding to a specific game or a subset thereof such as those designated by the game to be of a specific rank. In some embodiments, the success metrics are determined periodically.

In an example, the group of players are all players of a rank R, the category is offensive, and the success metric is determined to be “number of goals scored” divided by “number of attempts at the goal”. This success metric is determined by aggregating the success values, obtained at 1006, further described below, of the offensive analytical replays of players of rank R+1 (the next higher rank). Where success values of the R+1 players in the potential success metric are, for example, higher compared to the success values of players of rank R, the potential success metric is determined to be the success metric.

At 1006, the method 1000 includes determining a player wise success for each player. Determining the player wise success includes determining a success value for each player in the success metric. In some embodiments, the success metric is calculated based on set number of replays or matches. Continuing the above example, an offensive success value is determined for each player in the group of players based on analytical replays classified as event types, such as ceiling shots, ground shots, and the like, and corresponding to one of the last ten matches played by the player. The offensive success value for each player is determined to be the number of goals scored in these analytical replays divided by the total number of attempts at goal. The success values are written to a database such as the database 619 of FIG. 6 and 712 of FIG. 7. Using the classified analytical replays minimizes redundant processing beneficially minimizing processing power required.

At 1008, the method 1000 includes determining categories where a player is lacking. In some embodiments, a player is determined to be lacking where the player's success value is lacking compared to a predetermined benchmark for the category. The benchmark may be different for different groups. For example, higher rank groups may have higher benchmarks.

In some embodiments, determining where a player is lacking includes comparing a player wise success value of a specific player with the player wise success value of the remaining players in the group of players. Where a player is lacking compared to the other players of the group, the player is determined to be lacking in the category. In an example, the comparison is based on an ordered list of the players. The players are sorted by success value to obtain where each player stands in the category compared to other players of the group. Where the player is below a predetermined standing, for example in the bottom 50^{th} percentile, the player is determined to be lacking in the category. The comparison may be repeated for each category.

At 1010, where a player success is lacking in a category based on the success metric, the method 1000 includes suggesting a training plan corresponding to the category. The training plan may be for events corresponding to the success metric, such as ceiling shots, ground shots, and the like. Corresponding the training plan to the events of the success metric provides a path of least resistance training plan beneficially tailored to lead to an improvement (increase or decrease as the case may be) of the success value and corresponding advancement, such as in rank.

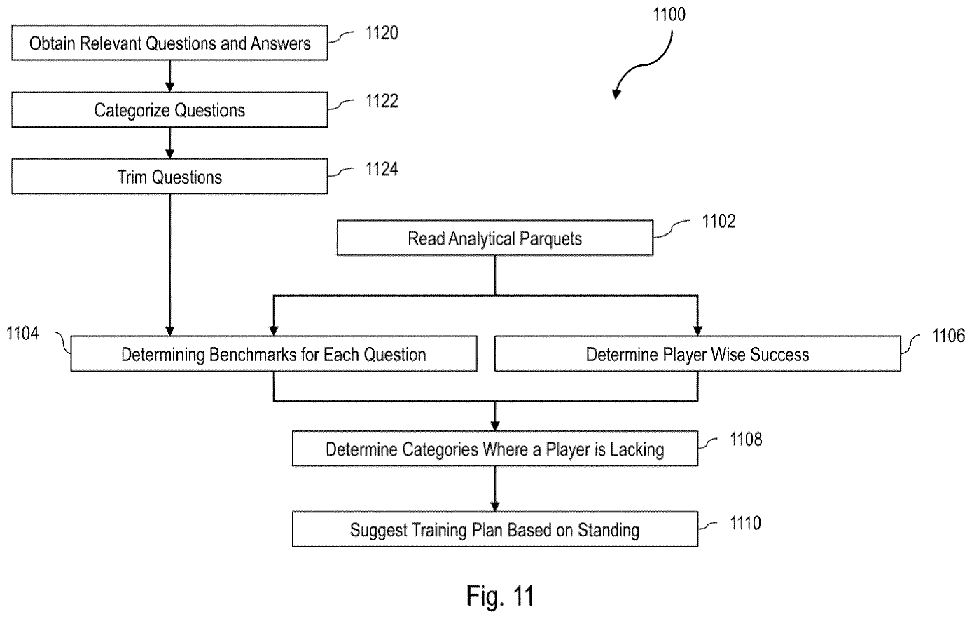

Referring now to FIG. 11, shown therein a flow diagram of a further method 1100 of determining and suggesting a training plan, according to and embodiment. The method 1100 may be a question and answer module benchmark calculation.

At 1120, the method 1100 includes obtaining questions and corresponding answers relevant to a specific game, such as rocket league. The questions and corresponding answer pairs may be obtained by scraping public or private web based discussion boards such as Reddit®, Google®, and YouTube®. It will be appreciated that questions and answers may be in different formats such as text, audio, and video.

At 1122, the method 1100 includes categorizing and ranking the questions. Categorizing the questions associates the questions with categories of player success such as offensive or defensive. The categories correspond to one or more event types. In some embodiments, the categorization and ranking are via a natural language processing (NLP) model. The ranking may be based on the frequency of occurrence or similar occurrence of each question.

At 1124, the method 1100 may include trimming the set of questions and answer pairs to a subset of beneficial questions and answers. The trimming may be based on a proscribed benefit of each question and answer pair. The proscribed benefit may be manually proscribed for each question and answer pair.

At 1102, the method 1000 includes reading analytical parquets of an event dataset such as the analytical parquets 709 of FIG. 7C. Reading the analytical parquets may be via a computation resources and configuration, such as a Databricks® cluster.

At 1104, the method 1000 includes determining a benchmark for a group of players corresponding to each beneficial question and answer. The benchmark may serve as a threshold to determine if a player is lacking in the corresponding category. Determining the benchmarks is based off the data read at 1102. Each category is defined by one or more event types. In some embodiments, the benchmark is calculated based on set number of replays or matches. In an example, an offensive success metric is determined based on analytical replays classified as event types, such as ceiling shot, corresponding to the offensive category and to one of the last ten matches played by each player in the group of players. The group of players may be all players of the system corresponding to a specific game. In some embodiments, the benchmark corresponds to a designated metric of the game. In an example, the questions and answers are separated by a rank of players corresponding to each question. The benchmarks are also determined by rank (i.e. rank wise) to correspond to the questions and answer set of each rank. In some embodiments, the benchmarks are determined periodically. The benchmarks are written to a database such as the database 619 of FIG. 6 and 712 of FIG. 7. A distributed computing framework and libraries such as PySpark may be used for aggregation to achieve the benchmarks across all ranks.

At 1006, the method 1000 includes determining a player wise success for each player. Determining the player wise success is similar to determining the success metric for all players but for a specific player. Data from 1002 may be used to calculate the success for each player. Using the same data may minimize redundant processing beneficially minimizing processing power required. A distributed computing framework and libraries such as PySpark may be used to find where players are doing well or poorly. The player wise successes are written to a database such as the database 619 of FIG. 6 and 712 of FIG. 7.

At 1008, the method 1000 includes determining categories where a player is lacking. Determining where a player is lacking includes comparing a player wise success in a particular category with the benchmark for that category. The comparison may be rank wise. The comparison may be repeated for each category.

At 1010, where a player success or a category is lacking based on the benchmark, the method 1000 includes suggesting a training plan corresponding to the category. The training plan includes the questions and corresponding answers. By providing the questions and answers the player is made aware of answers to questions indicated by categories where the player is lacking even if the player did not know to ask the question.

While the above description provides examples of one or more apparatus, methods, or systems, it will be appreciated that other apparatus, methods, or systems may be within the scope of the claims as interpreted by one of skill in the art.

1. A computer implemented system for analyzing video capture files of a game play to provide a training assessment comprising:
an input module configured to receive at least one raw replay file from one or more of a game, a game platform, and a user and provide the raw replay file to a parsing module;
the parsing module configured to:
parse each raw replay file to obtain a corresponding parsed replay file;
classify the parsed replay file wherein the parsed replay file is classified as any event type indicated by feature data of the parsed replay file;
where the parsed replay file is classified as at least one event type, save the parsed replay file in an event dataset; and
extract game event data from the saved parsed replay file and save the game event data in an event table schema.

2. The computer system of claim 1, wherein the input module is integrated into a backend of a game or a game platform.

3. The computer system of claim 1, wherein the input module provides an interface for one or more of a game, a game platform, and a user to upload the raw replay file.

4. The computer system of claim 1 further comprising a training assessment module configured to generate the training assessment based on the event dataset data, the event table schema data, and a trained model.

5. The system of claim 4 wherein trained model compares event dataset data to a benchmark, the benchmark determined based on one more of a path of least resistance calculation and a question and answer calculation.

6. The system of claim 4 wherein the trained model is a machine learning model.

7. The system of claim 4 wherein the training assessment comprises at least one suggested skill focus for a player.

8. The system of claim 7 wherein the suggested skill focus is based on a goal and the skill of a set of potential skills that is determined based on the event data set to be the least lacking skill to reach the goal.

9. The system of claim 1 wherein the input module is further configured to receive a batch comprising a plurality of raw replay files and wherein duplicate raw replay files are filtered out by the input module.

10. The system of claim 1 wherein the training is based on a training data and wherein the training data includes a plurality of input training assessments wherein the input training assessments include at least one first training assessment wherein the first training assessment is a training assessment of the training assessment generator.

11. The system of claim 1 wherein the feature data comprises one or more of features relating to game mechanics, feature relating to reaction times, metadata, in-game actions, player basic information, team selection information, play selection, player car position information, ball position information, player car demolish information, player car jump information, dodge information, double jump information, weapon choice information, team shooting information, individual map positioning/distance information, team map positioning/distance information, drop site information, map rotation information, character selection information, decision tree when ranking up information, team character makeup information, map positioning information, and team fighting information.

12. The system of claim 1 wherein the event dataset corresponds to one or more of a player and a team.

13. A computer implemented method for analyzing video capture files of a game play to provide a training assessment comprising:
receiving at least one raw replay file from one or more of a game, a game platform, and a user;
parsing each raw replay file to obtain a corresponding parsed replay file;
classifying the parsed replay file wherein the parsed replay file is classified as any event type indicated by feature data of the parsed replay file;
saving, where the parsed replay file is classified as at least one event type, the parsed replay file in an event dataset; and
extracting game event data from the saved parsed replay file and save the game event data in an event table schema.

14. The computer implemented method of claim 13, wherein the receiving the at least one raw replay file is via a backend of a game or a game platform.

15. The computer implemented method of claim 13, wherein receiving the at least one raw replay file is via an interface for one or more of a game, a game platform, and a user to upload the raw replay file.

16. The computer implemented method of claim 13 further generating the training assessment based on the event dataset data, the event table schema data, and a trained model.

17. The computer implemented method of claim 16 wherein trained model compares event dataset data to a benchmark, the benchmark determined based on one more of a path of least resistance calculation and a question and answer calculation.

18. The computer implemented method of claim 16 wherein the trained model is a machine learning model.

19. The computer implemented method of claim 16 wherein the training assessment comprises at least one suggested skill focus for a player.

20. The computer implemented method of claim 19 wherein the suggested skill focus is based on a goal and the skill of a set of potential skills that is determined based on the event data set to be the least lacking skill to reach the goal.

21. The computer implemented method of claim 13 further comprising receiving a batch comprising a plurality of raw replay files and filtering out duplicate raw replay files.

22. The computer implemented method of claim 13 wherein the training is based on a training data and wherein the training data includes a plurality of input training assessments wherein the input training assessments include at least one first training assessment wherein the first training assessment is a training assessment of the training assessment generator.

23. The computer implemented method of claim 13 wherein the feature data comprises one or more of features relating to game mechanics, feature relating to reaction times, metadata, in-game actions, player basic information, team selection information, play selection, player car position information, ball position information, player car demolish information, player car jump information, dodge information, double jump information, weapon choice information, team shooting information, individual map positioning/distance information, team map positioning/distance information, drop site information, map rotation information, character selection information, decision tree when ranking up information, team character makeup information, map positioning information, and team fighting information.

24. The computer implemented method of claim 13 wherein the event dataset corresponds to one or more of a player and a team.
